(19) United States
(12) Patent Application Publication
(10) Pub. No.: US 2012/0183933 A1
(43) Pub. Date: Jul. 19, 2012

(54) Dishware with Nutrition Guidance and Portion Tabulation

(76) Inventor: Ellen Mae Smiler, Encino, CA (US)

(21) Appl. No.: 13/352,306

(22) Filed: Jan. 17, 2012

Related U.S. Application Data
(60) Provisional application No. 61/433,888, filed on Jan. 18, 2011.
(60) Provisional application No. 61/513,340, filed on Jul. 29, 2011.

(51) Int. Cl. G09B 19/00

(52) U.S. Cl. 434/127

(57) ABSTRACT

A dishware item adapted to provide serving size guidance and tabulate portion size is described. The dishware item is optimized for use by young children, having functional and graphic design elements that provide stimulation, form a positive association with mealtime, and help instill a lifetime of healthy eating habits. The dishware item includes multiple food item compartments, each compartment associated with a type of food item. The dishware item also includes multiple tabulation counters, each counter associated with a food item compartment. In addition, the dishware item includes a non-skid base coupled to the food item compartments and the tabulation counters. The non-skid base is adapted to prevent movement of the dishware during use.

### CROSS-REFERENCE TO RELATED APPLICATIONS

This application claims the benefit of U.S. Provisional Application No. 61/433,888, filed on Jan. 18, 2011 and U.S. Provisional Application No. 61/513,340, filed on Jul. 29, 2011.

### BRIEF SUMMARY OF THE INVENTION

Various manufacturers typically provide dishware that allows food to be stored or served. Such dishware may include various compartments or features that may be used to separate various food items. In addition, dishware may include various entertainment elements to encourage reluctant eaters (e.g., young children).

One limitation of existing dishware with entertainment elements is that the entertainment elements are not associated with healthy eating habits (e.g., a selection of food items that is balanced across food groups, has appropriate serving sizes, etc.). Another limitation of existing dishware with entertainment elements is that the elements may be separate from the dishware, thus increasing clutter, increasing the effort required to store, maintain and use the dishware, increasing the probability of lost pieces, etc.

Therefore, there exists a need for stand-alone dishware that stimulates reluctant eaters, provides nutritional guidance for preparing meals, and tabulates the eaten portion of each food item.

In one aspect of the present invention, a dishware item is adapted to provide serving size guidance and tabulate portion size. The dishware item includes multiple food item compartments, where each compartment is associated with a type of food item. The dishware item also includes multiple tabulation counters and a non-skid base coupled to the food item compartments and the tabulation counters. The non-skid base is adapted to prevent movement of the dishware during use.

In another aspect of the present invention, a tabulation element is adapted to monitor portion size. The tabulation element includes multiple tabulation counters, where each tabulation counter associated with a type of food item. The tabulation element also includes a set of graphical representations of the types of food items, where each graphical representation is associated with a particular tabulation counter from the plurality of tabulation counters. In addition, the tabulation element includes a scale associated with the tabulation counters, where the scale is configured to indicate the relative portion size of each type of food item.

In yet another aspect of the present invention, a configurable, interactive game is adapted to motivate children to achieve proper nutrition. The game includes a set of nutrition goals, where each goal includes a target count. The game also includes a set of tabulation counters, where each tabulation counter is associated with a particular target count. In addition, the game includes a set of food item serving compartments adapted to store and serve related food items, where each compartment is associated with a particular tabulation counter.

The preceding Summary is intended to serve as a brief introduction to some embodiments of the invention. The Detailed Description that follows and the Drawings (or “Figures” or “FIGS.”) that are referred to in the Detailed Description will further describe the embodiments described in the Summary as well as other embodiments. Moreover, the claimed subject matter is not to be limited by the illustrative details in the Summary, but rather is to be defined by the appended claims.

### BRIEF DESCRIPTION OF THE DRAWINGS

The novel features of the invention are set forth in the appended claims. However, for purpose of explanation, several embodiments of the invention are set forth in the following drawings.

FIG. 1 illustrates a perspective view of a piece of dishware according to an exemplary embodiment the invention;

FIG. 2 illustrates a side view of the dishware of FIG. 1;

FIG. 3 illustrates a perspective view of the base of the dishware of FIG. 1;

FIG. 4 illustrates a perspective view of the dishware of FIG. 1, shown in use;

FIG. 5 illustrates a perspective view of the tabulation element of the dishware of FIG. 1, shown in use; and

FIG. 6 illustrates a top view of the dishware of FIG. 1, including compartment graphics.

### DETAILED DESCRIPTION

In the following detailed description of the invention, numerous details, examples, and embodiments of the invention are set forth and described. However, it will be clear and apparent to one skilled in the art that the invention is not limited to the embodiments set forth and that the invention may be practiced without some of the specific details and examples discussed.

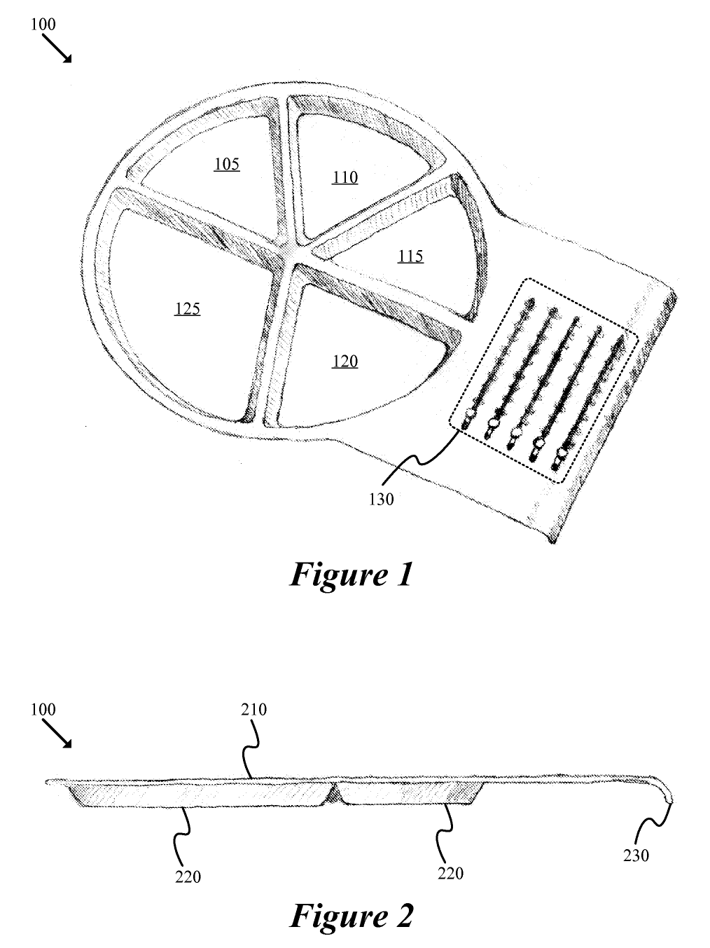

FIG. 1 illustrates a perspective view of a piece of dishware 100 according to an exemplary embodiment the invention. As shown, the dishware may include multiple compartments 105-125 that may each correspond to different types of food items (e.g., a “food group”) or otherwise related food items. In addition, the dishware 100 may include a tabulation element 130 that may allow a user of the dishware to tabulate portions of food items as the items are eaten.

The dishware 100 may be a plate, bowl, or other appropriate type of serving or storage receptacle. The dishware may include various appropriate materials or combinations of materials (e.g., plastic, ceramic, etc.). In addition, sections of the dishware (e.g., sections where food items will be placed) may include particular combinations of materials (e.g., food-grade plastic), while other sections of the dishware (e.g., the tabulation element 130) may include other particular combinations of materials (e.g., metal, plastic, etc.).

The dishware may generally be adapted to have a limited number of components for improved durability and ease of use. In addition, the components may be made from materials that allow the dishware to be used in a similar manner to other dishware (e.g., by being dishwasher-safe, microwaveable, waterproof, etc.).

The compartments 105-125 may be sized and/or shaped in various appropriate ways. As shown in FIG. 1, some embodiments may use a generally round-shaped plate that has pie-shaped compartments. Such compartments may be defined by a set of dividers that are radially aligned from the center of the plate. Some embodiments may have differently-shaped compartments (e.g., round, square, triangular, free-form, a combination of different shapes, etc.). Some embodiments may size the compartments such that each compartment is the same size as each other compartment. As shown in FIG. 1, in some embodiments the compartments may be sized such that at least one compartment is larger than at least one other compartment. Each compartment may hold one or more food items, which may be related (e.g., two types of fruit in one compartment, two types of vegetable in another compartment, etc.).

In some embodiments, the size of the compartments may correspond to recommended portions of various food items (e.g., government agency guidelines regarding recommended numbers of servings from each food group). In this manner, the size of the compartments may provide guidance to a meal preparer such that a healthy mix of food items is achieved. The configuration of the compartments may be customizable for different users and/or types of users. For instance, the nutritional guidelines may be different for young children than for elderly users. As such, the configuration of the compartments may be adjusted appropriately. As another example, custom configurations may be generated for various applications (e.g., implementing a restricted calorie diet, implementing a modified diet based on a condition (e.g., diabetes), and/or other applications).

The tabulation element 130 may include a number of tabulation counters. Such counters may correspond to the various compartments 105-125 of the dishware 100. In this manner, each tabulation counter may be used to tabulate an eaten portion of a food item corresponding to a particular compartment. For instance, each tabulation counter may be used to tabulate a number of portions (e.g., bites, spoonsful, forkfuls, etc.) eaten from a serving of a particular food item in a particular compartment. Such counting may allow food providers (e.g., parents) to set goals for the dishware users (e.g., children, aged two to six years old). Such goals may include a certain number of portions of each food item (e.g., three bites of fruit, two spoonsful of vegetable, etc.). In this way, the dishware may allow a user to fulfill a goal (or “win a game” in the case of young children), thus providing motivation for the user to implement a diet with proper nutrition. Furthermore, a food provider (e.g., a parent) may receive feedback and assurance that the user (e.g., young child) has consumed an appropriate amount of food with a desired nutritional balance.

FIG. 2 illustrates a side view of the dishware 100. As shown, in this example the dishware includes a flat top surface 210 that includes the lip of the plate and the top surface of the tabulation element 130. The dishware 100 of this example also includes a bottom surface that includes the base of each compartment 220 and a support element 230 adapted to match the depth of the compartments. In this manner, the dishware may lay flat on a surface (e.g., a table, countertop, etc.) and the tabulation element 130 may be supported at one side by the storage compartment bases 220 and at an opposite side by the support element 230. Different dishware may have different side profiles.

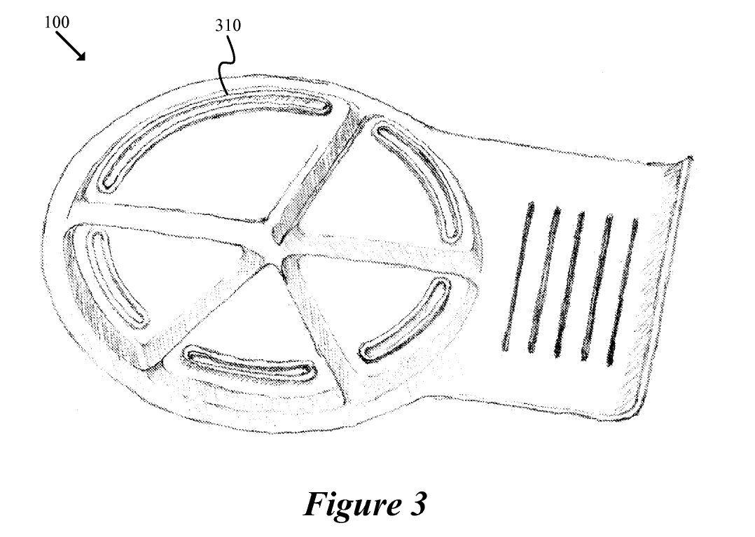

FIG. 3 illustrates a perspective view of the base (or underside) of the dishware 100. As shown, the dishware may include one or more non-skid elements 310 applied to the base of the dishware 100. Such non-skid elements 310 may prevent the dishware 100 from moving while the dishware is used (e.g., when the tabulation element 130 is updated). In this example, each non-skid element 310 is ring-shaped and there is a non-skid element associated with each compartment. Different embodiments may use different types, numbers, and/or configurations of non-skid elements, as appropriate (e.g., based on the size or shape of the dishware, the number of compartments in the dishware, etc.). For instance, some embodiments may not include any non-skid elements. As another example, some embodiments may include a single non-skid element that spans all compartments.

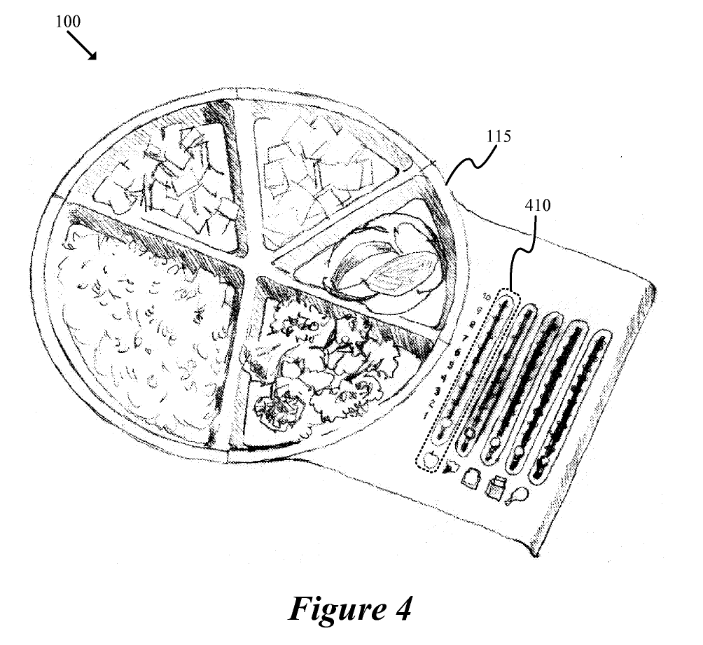

FIG. 4 illustrates a perspective view of the dishware 100, shown in use. In this example, the five compartments 105-125 correspond to five food groups (grain, protein, vegetable, dairy, and fruit). As shown in FIG. 4, each section has an appropriate example food choice (rice for grain, cubed chicken for protein, broccoli for vegetable, sliced cheese for dairy, and sliced apple for fruit). In this example, tabulation counter 410 is associated with the fruit compartment 115. Each tabulation counter may be associated with a different compartment. Each tabulation counter may include various graphic indicators showing the association between the tabulation counters and the compartments. For instance, referring to the example of FIG. 4, an area around tabulation counter 410 may be the same color as compartment 115 (or a portion thereof, e.g., the lip of the dishware at the outside arc of the compartment). The tabulation counter 410 may include an icon or other reference (e.g., an apple graphic to indicate an association with a fruit compartment) in addition to or in place of a color association.

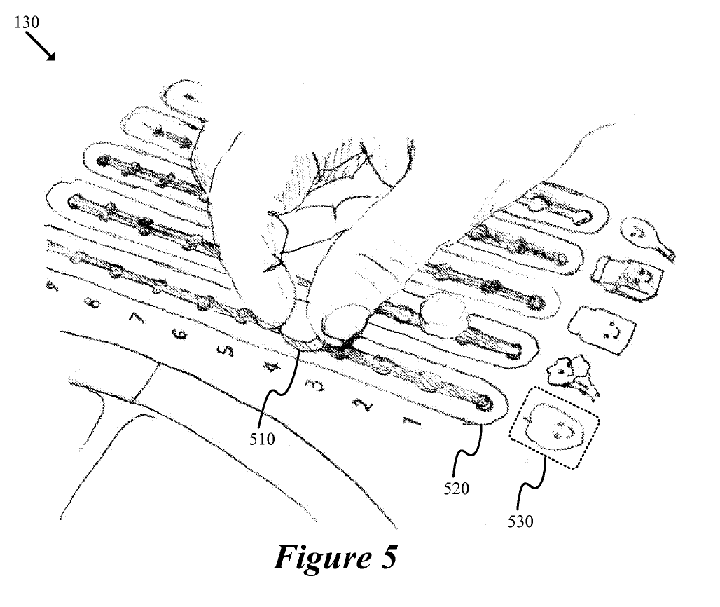

FIG. 5 illustrates a perspective view of the tabulation element 130 of the dishware 100, shown in use. As described above in reference to FIG. 4, the tabulation element 130 may include multiple tabulation counters 410. Each tabulation counter may be associated with a particular compartment. As shown in FIG. 5, each tabulation counter 410 may include an indicator 510, a scale 520, and/or an indication graphic 530. The indicator 510 may be a raised “button” that moves along a track formed in the surface of the dishware. The indicator may be configured such that it is easy to grasp and move by a variety of users. The track may include various indication points along the scale 520 that may be used to monitor a number of portions consumed by a user. Such indication points may be adapted such that the indicator “lock” into place due to movement resistance at the indication points compared to other sections along the track (this example uses round divots evenly spaced along the track). In addition, the indications points may each be associated with a count graphic (e.g., “1”, “2”, “3”, etc.). The scale 520 may include a colored section, where the color matches the color of a compartment associated with the scale. In addition, an indication graphic 530 may be associated with the scale 520. The indication graphic 530 may provide a visual reference that corresponds with the compartment associated with the scale.

Different embodiments may implement the tabulation element 130 in various different ways. For instance, some tabulation elements may include tabulation counters that have different numbers of indication points (e.g., the number of indication points may be based on a recommended serving size for the food item in the compartment associated with the tabulation counter), different ways of tabulating counts (e.g., a dial, a wheel, switches, an electronic counter, etc.), etc. However, the slider-style counters shown in FIG. 5 are effective in communicating advancement and progression to young children. The tabulation element may be customized based on the user and/or type of user. For instance, the number of indication points along each scale may correspond to a specific type of diet, nutrition goal, etc.

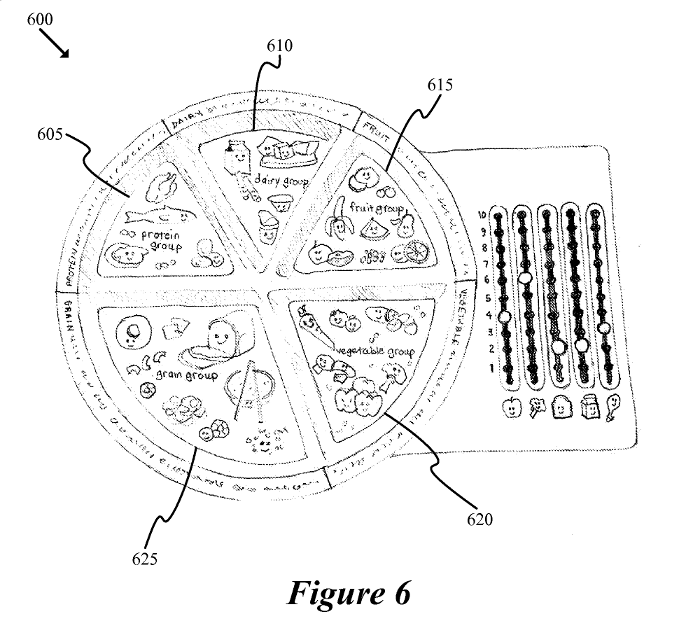

FIG. 6 illustrates a top view of dishware 600, including example compartment graphics. In this example, compartment 605 corresponds to the protein food group, with associated graphics. Compartment 610 corresponds to the dairy food group, with associated graphics. Compartment 615 corresponds to the fruit food group, with associated graphics. Compartment 620 corresponds to the vegetable food group, with associated graphics. Compartment 625 corresponds to the grain food group, with associated graphics. Each compartment may also be labeled with text, such that child users may be able to associate the description of the food group with visual representations of various food items in the food group. In addition, the graphics may be color-coded, such that the rim of the plate at each compartment has a color associated with a food group, the illustrations and text of the items in the food group may use the same color, and the slide associated with the compartment in the tabulation element may also use the same color.

The use of various appropriate colors (and/or other design elements) may stimulate children or others to be more committed and/or better enjoy the experiences of using the dishware and achieving any goals relating to eating a sufficient amount and/or eating a particular balance of food items. In such a way, positive associations with mealtime may be established for the users and also help establish healthy eating habits that persist even after use of the dishware may cease.

While the invention has been described with reference to numerous specific details, one of ordinary skill in the art will recognize that the invention can be embodied in other specific forms without departing from the spirit of the invention. For example, several embodiments were described above by reference to particular features and/or components. However, one of ordinary skill in the art will realize that other embodiments might be implemented with other types of features and components. One of ordinary skill in the art would understand that the invention is not to be limited by the foregoing illustrative details, but rather is to be defined by the appended claims.

I claim:

1. A dishware item adapted to provide serving size guidance and tabulate portion size, the dishware item comprising:
a plurality of food item compartments, each compartment associated with a type of food item;
a plurality of tabulation counters; and
a non-skid base coupled to the plurality of food item compartments and the plurality of tabulation counters, the non-skid base adapted to prevent movement of the dishware during use.

2. The dishware item of claim 1, wherein each tabulation counter is associated with a particular food item compartment.

3. The dishware item of claim 2, wherein each tabulation counter has a same color as the particular food item compartment associated with the tabulation counter.

4. The dishware item of claim 2, wherein each tabulation counter comprises a plurality of indication points, each indication point associated with a discrete count, the discrete count indicating a number of portions eaten.

5. The dishware item of claim 4, wherein each portion comprises a bite.

6. The dishware item of claim 1, wherein each food item compartment includes a plurality of graphical representation of food items from the type of food item associated with the food item compartment.

7. The dishware item of claim 1, wherein the types of food items include proteins, vegetable, fruits, grains and dairy.

8. The dishware item of claim 7, wherein each food item compartment is sized to correspond to a recommended serving size for the food item associated with the food item compartment.

9. A tabulation element adapted to monitor portion size, the tabulation element comprising:
a plurality of tabulation counters, each tabulation counter associated with a type of food item;
a set of graphical representations of the types of food items, each graphical representation associated with a particular tabulation counter from the plurality of tabulation counters; and
a scale associated with the tabulation counters, the scale configured to indicate the relative portion size of each type of food item.

10. The tabulation element of claim 9, each tabulation counter comprising:
a slider track;
a button adapted to move along the slider track.

11. The tabulation element of claim 10, each slider track including a set of indication points spaced along the track.

12. The tabulation element of claim 11, wherein the number of indication points in the set of indication points corresponds to a serving size.

13. The tabulation element of claim 9, wherein the tabulation element includes a first tabulation counter associated with fruit food items, a second tabulation counter associated with vegetable food items, a third tabulation counter associated with grain food items, a fourth tabulation counter associated with dairy food items, and a fifth tabulation counter associated with protein food items.

14. The tabulation element of claim 9, wherein the tabulation element is embedded in an item of dishware.

15. A configurable, interactive game adapted to motivate children to achieve proper nutrition, the game comprising:
a set of nutrition goals, each goal including a target count;
a set of tabulation counters, each tabulation counter associated with a particular target count; and
a set of food item serving compartments adapted to store and serve related food items, each compartment associated with a particular tabulation counter.

16. The game of claim 15, wherein the set of food item serving compartments includes a first food item serving compartment associated with fruit food items, a second food item serving compartment associated with vegetable food items, a third food item serving compartment associated with grain food items, a fourth food item serving compartment associated with dairy food items, and a fifth food item serving compartment associated with protein food items.

17. The game of claim 15, wherein each target count corresponds to a number of portions of a type of food item.

18. The game of claim 15, wherein each tabulation counter has the same color as the associated food item serving compartment.

19. The game of claim 15, wherein each tabulation counter comprises a slider track and a button indicator adapted to move along the slider track.

20. The game of claim 19, wherein the slider track comprises a plurality of indication points.
